(19) United States
(12) Patent Application Publication
(10) Pub. No.: US 2008/0163812 A1
(43) Pub. Date: Jul. 10, 2008

(54) Bell Device Mounted on a Vehicle Handle

(76) Inventor: Shen-Keng LIN, Changhua Hsien (TW)

Correspondence Address: BANNER & WITCOFF, LTD., 1100 13th STREET, N.W., SUITE 1200, WASHINGTON, DC, 20005-4051, US

(21) Appl. No.: 11/621,358

(22) Filed: Jan. 9, 2007

(51) Int. Cl. G10K 1/00; G10K 5/00

(52) U.S. Cl. 116/137 R; 116/148

(57) ABSTRACT

A bell device is mounted on a vehicle handle, and includes a mounting seat and a sound-generating unit. The mounting seat includes a sleeve portion sleeved fixedly on the vehicle handle, and a pivot portion connected fixedly to the sleeve portion. The sound-generating unit includes a rotatable body disposed rotatably on the mounting seat, a bell body disposed on an assembly of the pivot portion and the rotatable body, a knocking hammer disposed in proximity to the bell body, and a resilient member interconnecting the knocking hammer and the rotatable body. The knocking hammer is operable to strike against the bell body to thereby generate a bell sound. The sound-generating unit further includes a whistle member disposed within the knocking hammer. Preferably, the rotatable body of the sound-generating unit is connected removably to the mounting seat.

### BACKGROUND OF THE INVENTION

1. Field of the Invention

This invention relates to a bell, and more particularly to a bell device mounted on a vehicle handle, such as a bicycle handle.

2. Description of the Related Art

Referring to FIG. 1, a conventional bicycle bell device includes a mounting seat 1, and a sound-generating unit 2. The mounting seat 1 has a sleeve portion 101 sleeved fixedly on a bicycle handle 3, and a pivot portion 102 connected fixedly to the sleeve portion 101. The pivot portion 102 is formed with a disk 103, and a pivot post 104 extending upwardly from the disk 103. The sound-generating unit 2 includes a rotatable body 201 sleeved rotatably on the pivot post 104, a bell body 202 disposed fixedly on and above the pivot post 104, a coiled compression spring 203 sleeved on the pivot post 104 between the bell body 202 and the rotatable body 201, a knocking hammer 204 disposed in proximity to the bell body 202, and a coiled tension spring 205 interconnecting the knocking hammer 204 and the rotatable body 201. The rotatable body 201 is rotatable on the mounting seat 1 for adjusting the position of the knocking hammer 204 relative to the bell body 202.

The knocking hammer 204 can be moved away from the bell body 202. Subsequently, when the knocking hammer 204 is released, it strikes against the bell body 202 several times to thereby generate a bell sound.

The aforesaid conventional bicycle bell device suffers from the following disadvantages:
(1) When the rider is away from the bicycle, the bell body 202 may be stolen by use of a screwdriver (not shown).
(2) The bicycle bell device has only a bell sound-generating function.

### SUMMARY OF THE INVENTION

An object of this invention is to provide a bell device that is mounted on a vehicle handle and that includes a bell body, which can be removed easily from the vehicle handle by a rider without use of a tool such that the rider can carry the bell body when he or she is away from the vehicle, thereby preventing the bell body from being stolen.

Another object of this invention is to provide a bell device that is mounted on a vehicle handle and that includes a whistle member which can provide an additional function to the bell device.

According to an aspect of this invention, there is provided a bell device adapted to be mounted on a vehicle handle and comprising:

a mounting seat including a sleeve portion adapted to be sleeved fixedly on the vehicle handle, and a pivot portion connected fixedly to the sleeve portion; and

a sound-generating unit including a rotatable body disposed rotatably on the mounting seat, a bell body disposed on the rotatable body, a knocking hammer disposed in proximity to the bell body, and a resilient member interconnecting the knocking hammer and the rotatable body such that the knocking hammer is operable to strike against the bell body to thereby generate a bell sound;

wherein the rotatable body of the sound-generating unit is connected removably to the mounting seat.

According to another object of this invention, there is provided a bell device adapted to be mounted on a vehicle handle and comprising:

a mounting seat including a sleeve portion adapted to be sleeved fixedly on the vehicle handle, and a pivot portion connected fixedly to the sleeve portion; and

a sound-generating unit including a rotatable body disposed rotatably on the mounting seat, a bell body disposed on the pivot portion, a knocking hammer disposed in proximity to the bell body, and a resilient member interconnecting the knocking hammer and the rotatable body such that the knocking hammer is operable to strike against the bell body to thereby generate a bell sound;

wherein the sound-generating unit further includes a whistle member disposed within the knocking hammer.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a sectional view of a conventional bicycle bell device;

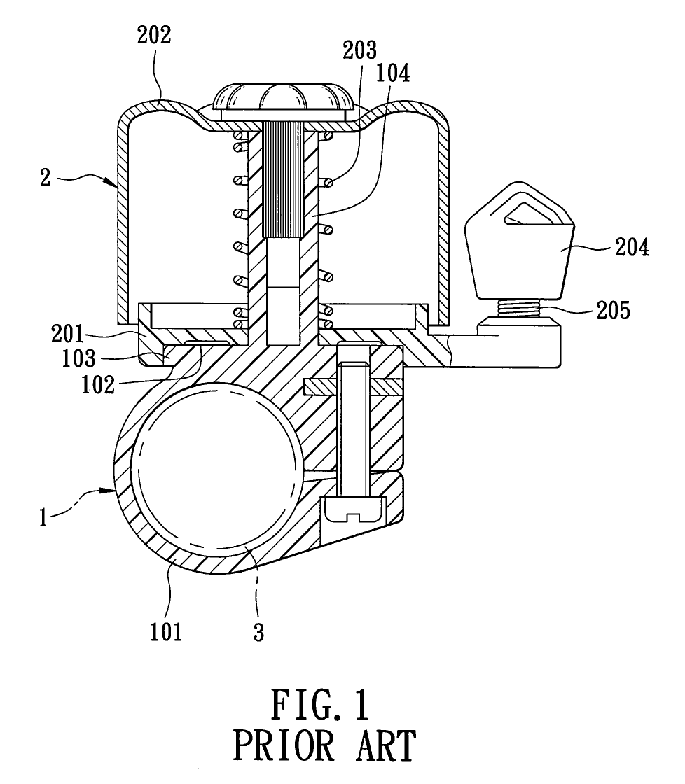

FIG. 2 is an exploded perspective view of the first preferred embodiment of a bell device according to this invention;

FIG. 3 is a sectional view of the first preferred embodiment;

FIG. 4 is a schematic sectional view of the first preferred embodiment, illustrating the operation of a knocking hammer;

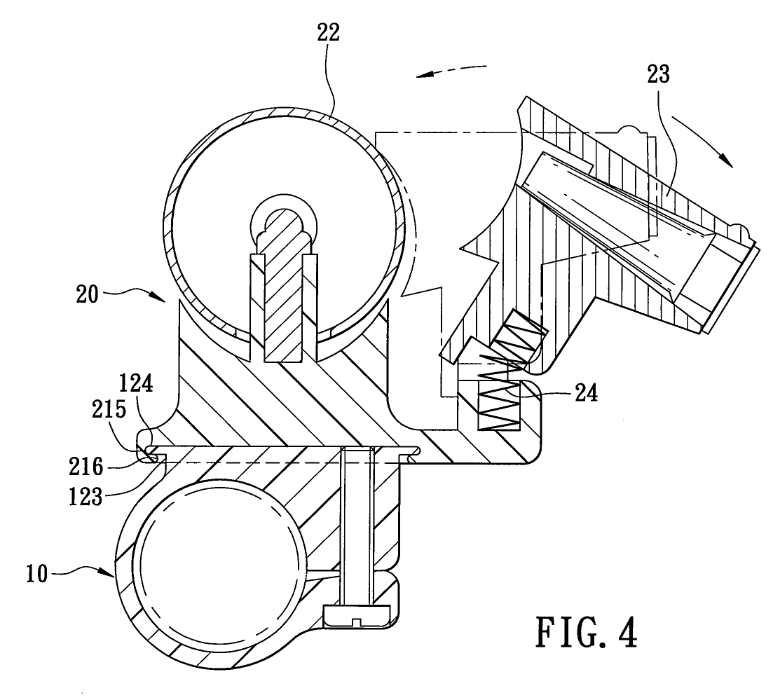

FIG. 5 is a schematic sectional view of the first preferred embodiment, illustrating how a sound-generating unit is removed from a mounting seat;

FIG. 6 is a schematic view illustrating how the sound-generating unit of the first preferred embodiment is used as a whistle when it is removed from the mounting seat;

FIG. 7 is an exploded perspective view of the second preferred embodiment of a bell device according to this invention;

FIG. 8 is a sectional view of the second preferred embodiment; and

FIG. 9 is a sectional view of the third preferred embodiment of a bell device according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

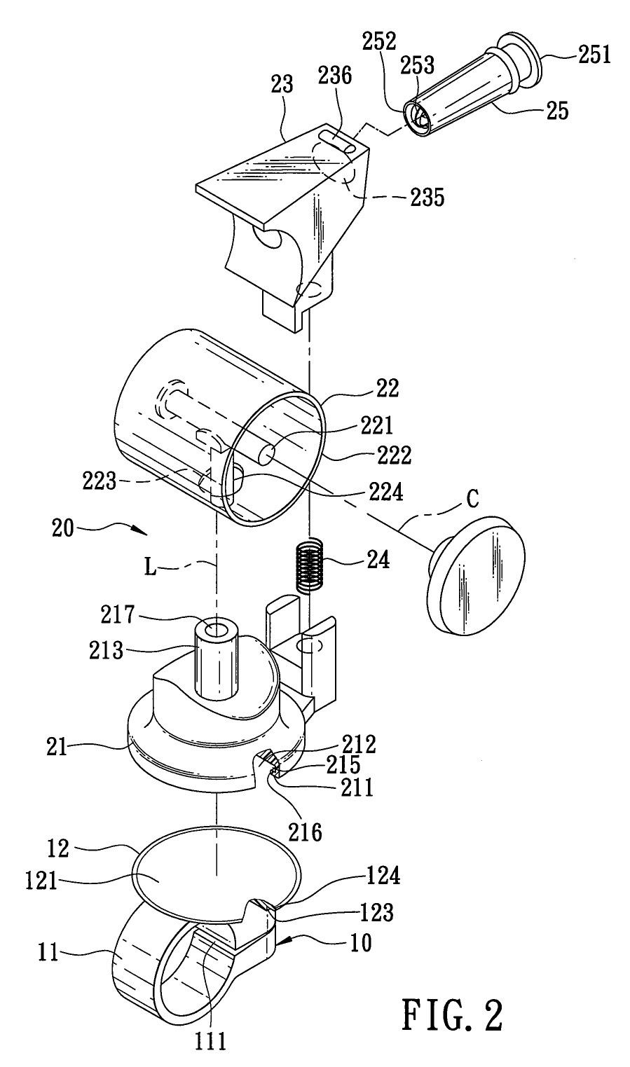

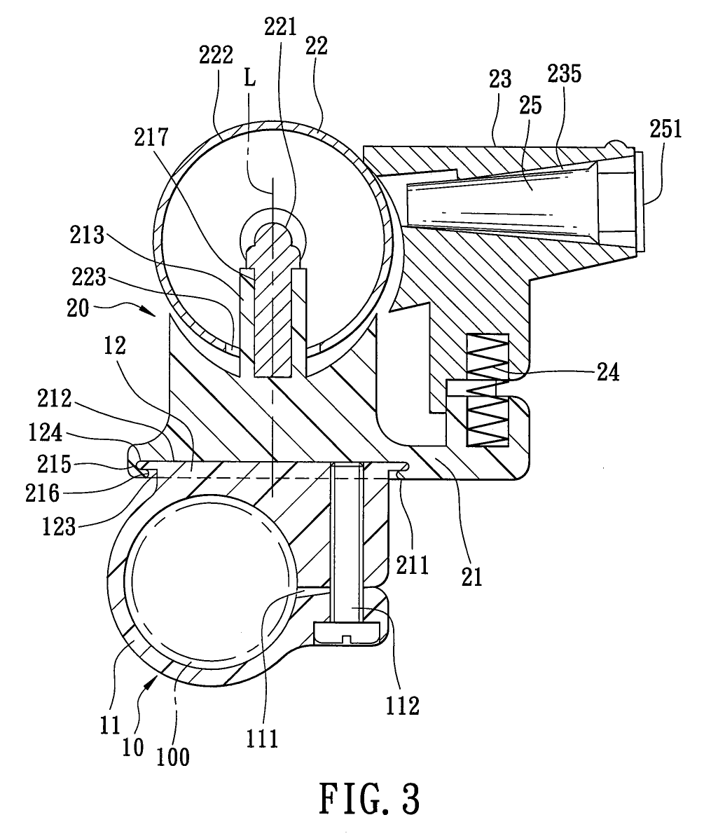

Referring to FIGS. 2 and 3, the first preferred embodiment of a bell device according to this invention is mounted on a vehicle handle 100, such as a bicycle handle. The bell device includes a mounting seat 10 and a sound-generating unit 20 rotatable relative to the mounting seat 10.

The mounting seat 10 includes a sleeve portion 11 sleeved fixedly on the vehicle handle 100, and a pivot portion 12 connected fixedly to the sleeve portion 11. The sleeve portion 11 has an opening 111, and a bolt 112 operable in a known manner to reduce or eliminate the opening 111.

The sounding-generating unit 20 includes a rotatable body 21, a bell body 22 disposed on the rotatable body 21, a knocking hammer 23 disposed in proximity to the bell body 22, a resilient member 24 configured as a coiled tension spring and interconnecting the knocking hammer 23 and the rotatable body 21, and a whistle member 25 disposed removably within a through hole 235 in the knocking hammer 23.

The knocking member 23 is formed with an anti-slip projecting strip 236 for contact with a hand of an operator. The knocking hammer 23 can be moved away from the bell body 22. Subsequently, when the knocking hammer 23 is released, it strikes against the bell body 22 several times to thereby generate a bell sound.

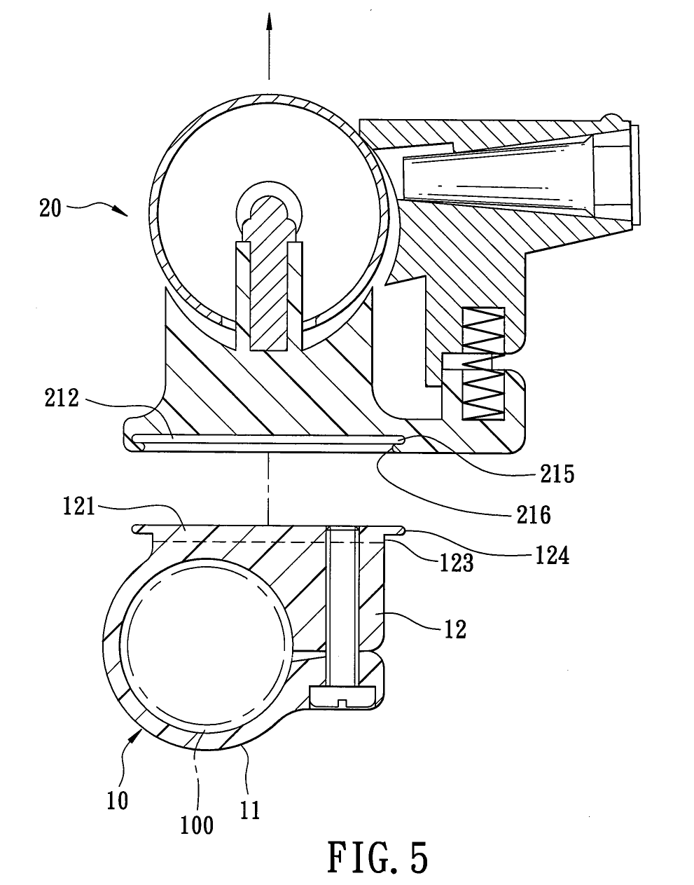

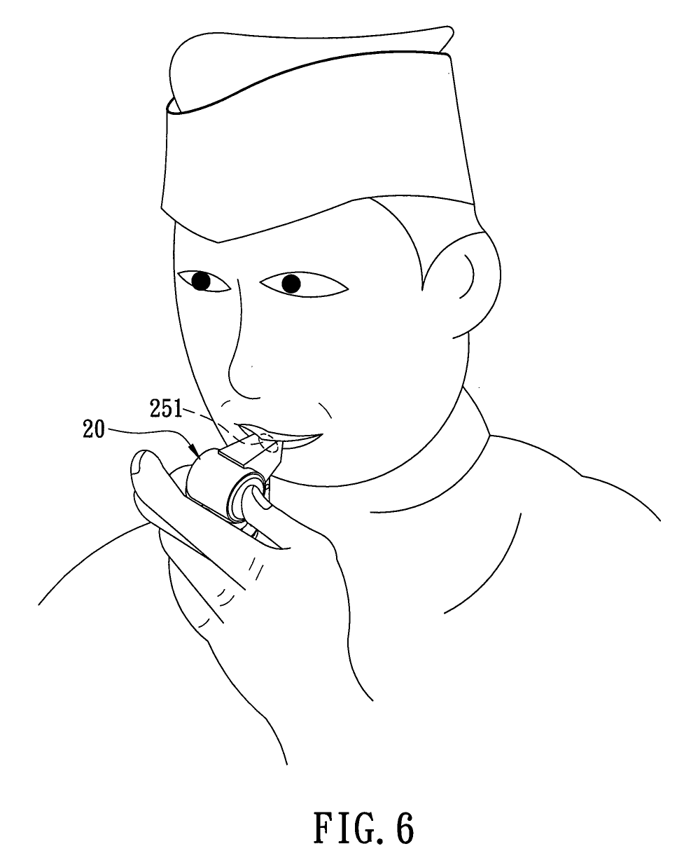

The rotatable body 21 has a bottom surface 211 formed with a recess 212. The mounting seat 10 is formed with a projection 121 in the form of a disk for engaging fittingly the recess 212. As such, the rotatable body 21 is rotatable about the mounting seat 10 about a central axis (L) (see FIG. 3). The recess 212 has an upper recess portion 215 and a lower recess portion 216 that is connected to and disposed under the upper recess portion 215 and that has a diameter smaller than that of the upper recess portion 215. The projection 121 has an upper projection portion 124 engaging fittingly the upper recess portion 215, and a lower projection portion 123 engaging fittingly the lower recess portion 216 so as to allow for rotation of the projection 121 within the recess 212. Since each of the mounting seat 10 and the rotatable body 21 is made of a plastic material, a force can be applied to the rotatable body 21 so as to pull the rotatable body 21 away from the mounting seat 10, thereby removing the projection 121 from the recess 212, as shown in FIG. 5. Thereafter, the sound-generating unit 20 may be used as a whistle, as shown in FIG. 6.

The rotatable body 21 is formed with an integral upright tube 213 having a central hole 217 extending along the central axis (L). The bell body 22 includes a cylindrical shell 222 perpendicular to the upright tube 213 and having two closed ends, an axial rod 221 disposed fixedly within the cylindrical shell 222 and extending along a central axis (C) of the cylindrical shell 222, an opening 223 formed through a wall of the cylindrical shell 222 and disposed under the axis rod 221, and a radial rod 224 connected fixedly to the axial rod 221 and extending through the opening 223. The upright tube 213 extends fittingly through the opening 223, and is sleeved on the radial rod 224 in a close-fitting manner.

The whistle member 25 is elongated, and has an air inlet end 251, an air outlet end 252 opposite to the air inlet end 251, and a sound generator 253 disposed within the whistle member 25 between the air inlet end 251 and the air outlet end 252. The sound generator 253 includes a plurality of interconnected reeds.

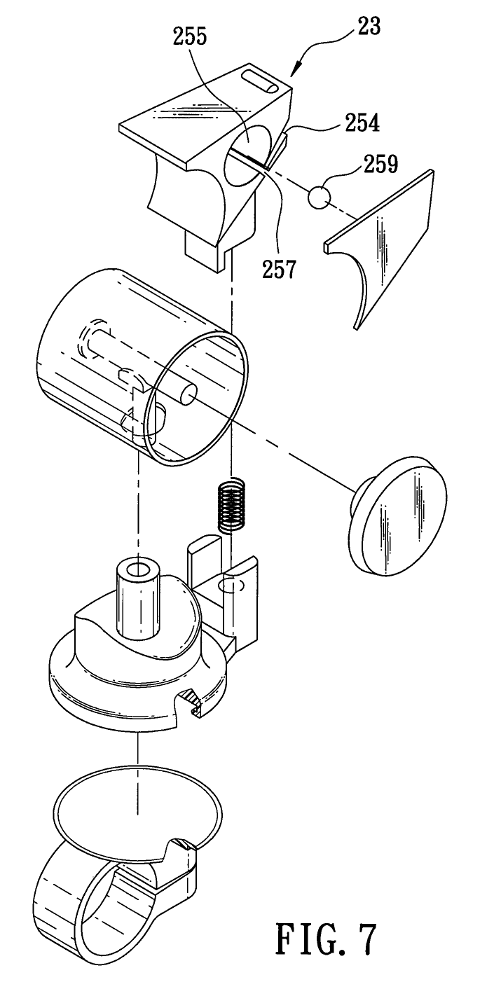

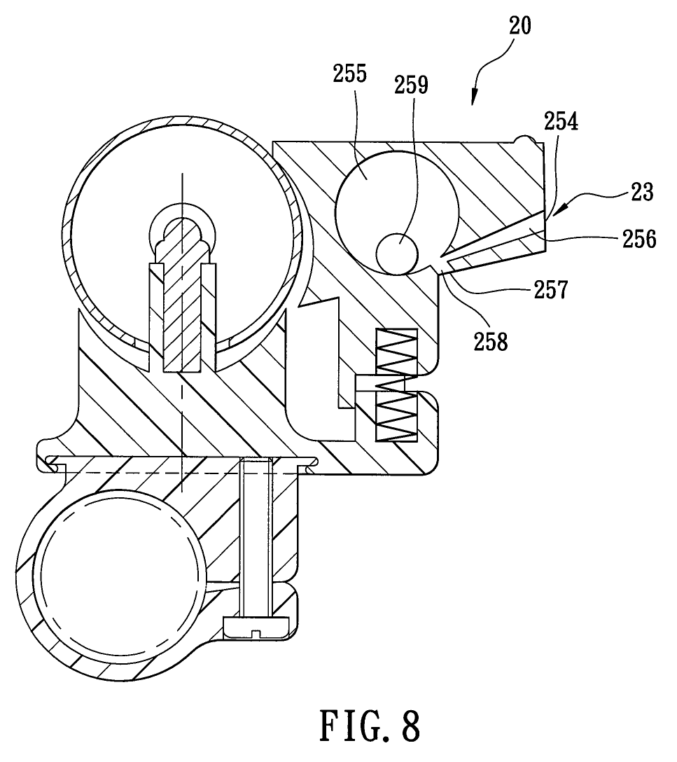

FIGS. 7 and 8 show the second preferred embodiment of a bell device according to this invention, which is a modification of the first preferred embodiment. In contrast to the first preferred embodiment, the whistle member 25 (see FIG. 2) is omitted, and the knocking hammer 23 is configured as a whistle, and includes an air inlet 254, a cylindrical air chamber 255, an entrance passage 256 in fluid communication with the air inlet 254 and the air chamber 255, an air outlet 257, an exit passage 258 in fluid communication with the air outlet 257 and the air chamber 255, and a ball 259 rollable within the air chamber 255. The entrance and exit passages 256, 258 extend from the air chamber 255 at the same position.

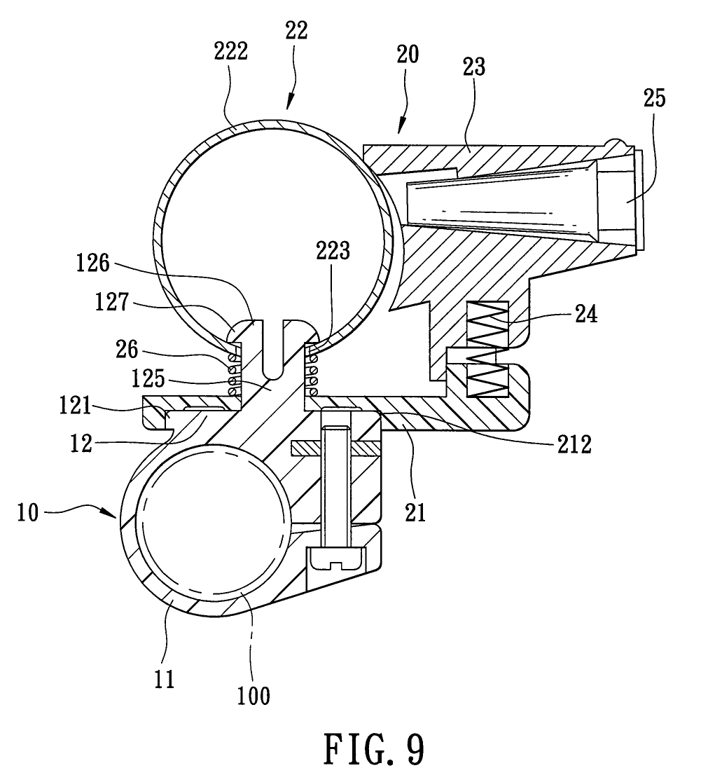

Referring to FIG. 9, the third preferred embodiment of a bell device according to this invention is mounted on a vehicle handle 100, and includes a mounting seat 10 and a sound-generating unit 20. The mounting seat 10 includes a sleeve portion 11 sleeved fixedly on the vehicle handle 100, and a pivot portion 12 connected fixedly to the sleeve portion 11.

The sound-generating unit 20 includes a rotatable body 21, a bell body 22 disposed on the pivot portion 12, a knocking hammer 23, a resilient member 24, a whistle member 25, and a coiled compression spring 26. The structures of the knocking member 23, the resilient member 24, and the whistle member 25 are similar to those of the first preferred embodiment, and may be replaced with those of the second preferred embodiment.

The rotatable body 21 has a bottom surface formed with a recess 212. The bell body 22 includes a generally horizontal cylindrical shell 222 having a bottom portion formed with an opening 223. The mounting seat 10 is formed with a projection 121 engaging fittingly the recess 212, and an integral post 125 that extends upwardly from the projection 121 through the rotatable body 21 and that has a bifurcated top end portion. The bifurcated top end portion includes an adjacent pair of spaced-apart parallel resilient arms 126 each formed with a barbed top end. The resilient arms 126 extend through the opening 223, and are formed respectively with two aligned protrusions 127 extending away from each other. The protrusions 127 are sized so as to prevent removal of the resilient arms 126 from the bell body 22 via the opening 223. The coiled compression spring 26 is sleeved on the post 125 between the bell body 22 and the rotatable body 21 so as to bias the bell body 22 to move away from the rotatable body 21. As such, the rotatable body 21 is rotatable on the mounting seat 10.

With this invention thus explained, it is apparent that numerous modifications and variations can be made without departing from the scope and spirit of this invention. It is therefore intended that this invention be limited only as indicated by the appended claims.

I claim:

1. A bell device adapted to be mounted on a vehicle handle and comprising:
a mounting seat including a sleeve portion adapted to be sleeved fixedly on the vehicle handle, and a pivot portion connected fixedly to said sleeve portion; and
a sound-generating unit including a rotatable body disposed rotatably on said mounting seat, a bell body disposed on said rotatable body, a knocking hammer disposed in proximity to said bell body, and a resilient member interconnecting said knocking hammer and said rotatable body such that said knocking hammer is operable to strike against said bell body to thereby generate a bell sound;
wherein said rotatable body of said sound-generating unit is connected removably to said mounting seat.

2. The bell device as claimed in claim 2, wherein said rotatable body has a bottom surface formed with a recess, said mounting seat being formed with a projection engaging fittingly said recess in said rotatable body such that said rotatable body is rotatable about said projection.

3. The bell device as claimed in claim 2, wherein said recess in said rotatable body has an upper recess portion and a lower recess portion that is connected to and disposed under said upper recess portion and that has a diameter smaller than that of said upper recess portion, said projection having an upper projection portion engaging fittingly said upper recess portion, and a lower projection portion engaging fittingly said lower recess portion so as to allow for rotation of said projection within said recess, each of said mounting seat and said rotatable body being made of a plastic material such that a force can be applied to said rotatable body so as to pull said rotatable body away from said mounting seat, thereby removing said projection from said recess.

4. The bell device as claimed in claim 1, wherein said rotatable body is formed with an integral upright tube, said bell body including a cylindrical shell perpendicular to said upright tube and having two closed ends, an axial rod disposed fixedly within said cylindrical shell and extending along a central axis of said cylindrical shell, an opening formed through a wall of said cylindrical shell and disposed under said axial rod, and a radial rod connected fixedly to said axial rod and extending through said opening, said upright tube extending fittingly through said opening and being sleeved on said radial rod in a close-fitting manner.

5. The bell device as claimed in claim 1, wherein said sound-generating unit further includes a whistle member disposed removably within said knocking hammer, said whistle member being elongated and having an air inlet end, an air outlet end opposite to said air inlet end, and a sound generator disposed within said whistle member between said air inlet end and said air outlet end.

6. The bell device as claimed in claim 5, wherein said sound generator includes a plurality of interconnected reeds.

7. The bell device as claimed in claim 1, wherein said knocking hammer is configured as a whistle, and includes an air inlet, an air chamber, an entrance passage in fluid communication with said air inlet and said air chamber, an air outlet, an exit passage in fluid communication with said air outlet and said air chamber, and a ball rollable within said air chamber, said entrance and exit passages extending from said air chamber at the same position.

8. The bell device as claimed in claim 1, wherein said resilient member is configured as a coiled tension spring.

9. A bell device adapted to be mounted on a vehicle handle and comprising:
a mounting seat including a sleeve portion adapted to be sleeved fixedly on the vehicle handle, and a pivot portion connected fixedly to said sleeve portion; and
a sound-generating unit including a rotatable body disposed rotatably on said mounting seat, a bell body disposed on said pivot portion, a knocking hammer disposed in proximity to said bell body, and a resilient member interconnecting said knocking hammer and said rotatable body such that said knocking hammer is operable to strike against said bell body to thereby generate a bell sound;
wherein said sound-generating unit further includes a whistle member disposed within said knocking hammer.

10. The bell device as claimed in claim 9, wherein said whistle member is disposed removably within said knocking hammer, is elongated, and has an air inlet end, an air outlet end opposite to said air inlet end, and a sound generator disposed within said whistle member between said air inlet end and said air outlet end.

11. The bell device as claimed in claim 10, wherein said sound generator includes a plurality of interconnected reeds.

12. The bell device as claimed in claim 9, wherein said knocking hammer includes an air inlet, an air chamber, an entrance passage in fluid communication with said air inlet and said air chamber, an air outlet, an exit passage in fluid communication with said air outlet and said air chamber, and a ball rollable within said air chamber, said entrance and exit passages extending from said air chamber at the same position, an assembly of said air inlet, said air chamber, said entrance passage, said air outlet, said exit passage, and said ball constituting said whistle member.

13. The bell device as claimed in claim 9, wherein
said rotatable body has a bottom surface formed with a recess;
said bell body includes a generally horizontal cylindrical shell having a bottom portion formed with an opening;
said mounting seat is formed with a projection engaging fittingly said recess in said rotatable body 21, and an integral post that extends upwardly from said projection through said rotatable body and that has a bifurcated top end portion, said bifurcated top end portion including an adjacent pair of spaced-apart parallel resilient arms each formed with a barbed top end, said resilient arms extending through said opening and being formed respectively with two aligned protrusions extending away from each other, said protrusions being sized so as to prevent removal of said resilient arms from said bell body via said opening; and
said bell device further includes a coiled compression spring sleeved on said post of said mounting seat between said bell body and said rotatable body so as to bias said bell body to move away from said rotatable body.

14. The bell device as claimed in claim 9, wherein said resilient member is configured as a coiled tension spring.
